(19) United States
(12) Patent Application Publication
(10) Pub. No.: US 2002/0109753 A1
(43) Pub. Date: Aug. 15, 2002

(54) High density jetting a high density jetting apparatus

(76) Inventors: Yi-Jing Leu, Hsin-Chu City (TW); Hung-Sheng Hu, Kao-Hsiung City (TW); Chung-Cheng Chou, Taipei City (TW); Tsung-Ping Hsu, Tao-Yuan Hsien (TW); In-Yao Lee, Taipei Hsien (TW); Wei-Lin Chen, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 09/683,633

(22) Filed: Jan. 29, 2002

(30) Foreign Application Priority Data
Feb. 15, 2001 (TW) 090103476

(51) Int. Cl. B41J 2/05

(52) U.S. Cl. 347/56

(57) ABSTRACT

A high density jetting apparatus for a print head of an inkjet printer includes a manifold, at least two fluid chambers, orifices located on two sides of the manifold, and several bubble generating devices installed adjacent to two sides of the orifices. These bubble generating devices heat fluid inside the fluid chamber to generate two consecutive bubbles and eject fluid between the first and second bubbles from the orifice. The fluid chambers and orifices are arranged symmetrically or asymmetrically with respect to the manifold to increase the number of orifices and decrease turbulent effect, thereby improving print quality.

### BACKGROUND OF INVENTION

1. Field of the Invention

The present invention relates to a jetting apparatus, in particular, to a high density jetting apparatus of an inkjet print head with several orifices and reduced interference between adjacent orifices.

2. Description of Prior Art

The thermal, bubble jet print head has been developed and used for decades. The principal is simple: ink fills a chamber in the print head. Then the ink is heated until a bubble forms. The bubble forces the ink from the chamber—and presumably onto the paper—then collapses. Because the device is so small, it can be refilled every 10 to 100 microseconds. Satellite droplets, which are an annoying and common problem in thermal bubble jet printer applications are formed when the “tails” of elongated droplets break off and strike the paper at unintended locations.

Please refer to FIG. 1. FIG. 1 is a schematic diagram depicting a print head according to the prior art. A print head typically comprises a substrate 10, a manifold 11 for passing fluid such as ink from a reservoir (not shown), a chamber 12, an orifice 13 for ejecting the fluid, and heaters 14a and 14b located on either side of the orifice 13. A similar print head structure is described in U.S. Pat. No. 6,102,530 entitled “Apparatus and Method for Using Bubbles as Virtual Valve in Microinjector to eject fluid” assigned to Kim et al. and issued on Aug. 15 2000.

With reference to U.S. Pat. No. 6,102,530, the heater 14a has a narrower cross-section compared to the heater 14b. Consequently, there is a higher power dissipation of a current pulse in the heater 14a. Therefore, in response to a common electrical pulse, the heater 14a heats up at a faster rate than the heater 14b. The activation of the heater 14a causes a first bubble (not shown) to form between the manifold 11 and the chamber 12, which restricts the flow of fluid to the manifold 11. A virtual valve accordingly forms, which isolates chamber 12 and shields adjacent chambers from cross talk. A second bubble (not shown) is formed under the heater 14b after formation of the first bubble, and as the second bubble expands, the chamber 12 is pressurized, causing fluid to be ejected through the orifice 13. Coalescence of the first and second bubbles prevents the formation of satellite droplets.

According to U.S. Pat. No. 6,102,530, the manifold 11 and the fluid chamber 12 are formed by an anisotropic etching process from a backside of the substrate 10. When assembling a reservoir and a print head, a sufficient clue area is needed on backside of the silicon substrate 10 to ensure amalgamation between the reservoir and the print head. Inevitably, a large surface area of backside of the silicon substrate 10 is wasted. Different etching rates in different lattice directions caused by anisotropic etching result in a hole extending through an angle of approximately 54.7° from the backside to the front side of the silicon substrate 10 thus wasting a large area of space on the backside of the substrate 10. The geometric problem of the prior art directly reflects onto the resolution of a print head.

FIG. 2 shows a cross-sectional view of a prior art microinjector array. Assuming that the manifold 31 has a width of only 200 μm, the minimum width of the hole formed on the backside is approximately 1156 μm. According to the prior art, a minimum backside width of 3556 μmis needed after considering two glued sides of each approximately 1200 μm wide.

FIG. 3 is a plane view of prior art print head array. In FIG. 3, orifices 23 are arranged on one side of the manifold 21. To achieve a high resolution such as 600 dpi or higher a closer packing of chamber and orifice arrangement must be considered. As explained above, this is limited by the backside surface of the substrate 10 since the chamber and the manifold are formed by using anisotropic etching from the backside surface of the substrate 10. Another resolution is to create two manifolds such as the cross section view depicted in FIG. 3. However, this method consumes more substrate or chip size and is therefore not cost effective. So, the requirement is for a high density, high resolution jetting apparatus for a print head without increasing the chip size.

### SUMMARY OF INVENTION

It is therefore a primary objective of the claimed invention to provide a high density jetting apparatus and a method for making the apparatus.

According to the claimed invention, the high density jetting apparatus comprises a manifold, at least two fluid chambers located at two sides of the manifold for passing fluid from the manifold, an orifice formed above each of the fluid chambers, a first bubble generating device installed adjacent to one side of the orifice for heating fluid inside the fluid chamber to create a first bubble, a second bubble generating device installed adjacent to the other side of the orifice for heating fluid inside the fluid chamber to create a second bubble subsequent to creation of the first bubble so that the fluid between the first and second bubbles can be ejected from the orifice. The orifices and the chambers are arranged in a symmetric or asymmetric manner on two sides of each manifold.

It is an advantage of the claimed invention that the number of orifices can be increased so as to increase a print resolution of the high density jetting apparatus and cross talk between adjacent chambers is reduced.

These and other objectives and advantages of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a schematic diagram depicting a print head according to the prior art.

FIG. 2 is a cross-sectional view of prior art microinjector array.

FIG. 3 is a plane view of prior art print head array.

FIG. 4 and FIG. 5 illustrate the process and the structure of fabricating the jetting apparatus according to the present invention.

FIG. 6 is a top view of the high density jetting apparatus.

FIG. 7 illustrates a second preferred embodiment of the high density jetting apparatus.

FIG. 8 illustrates a third preferred embodiment of the high density jetting apparatus according to the present invention.

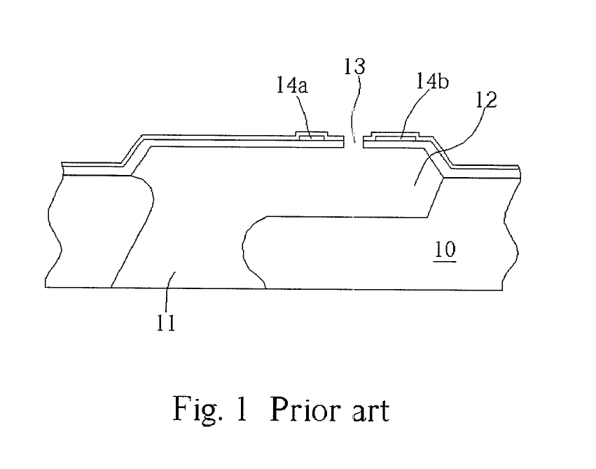

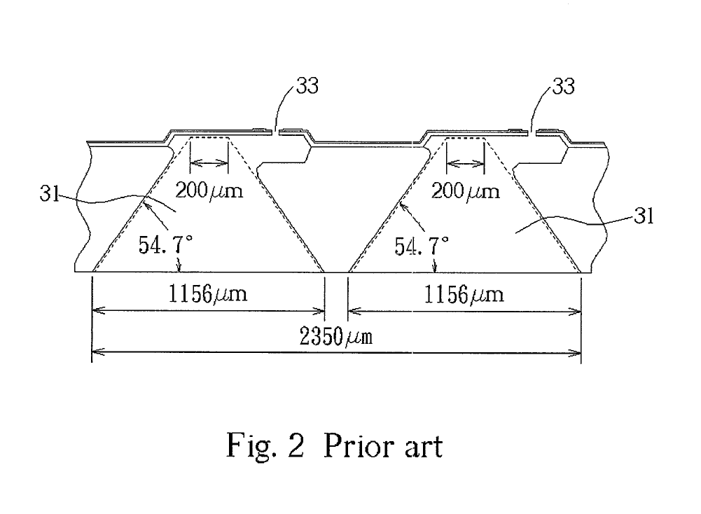

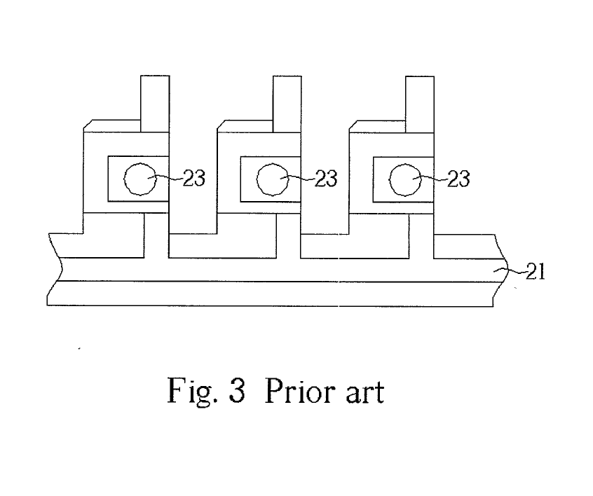

### DETAILED DESCRIPTION

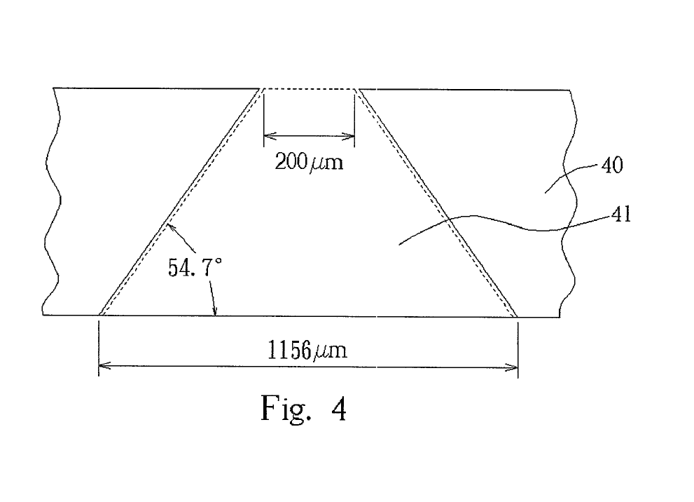

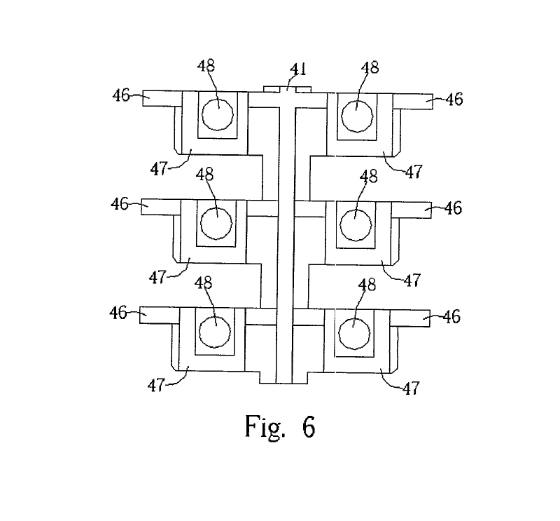

Please refer to FIG. 4 to FIG. 6. FIG. 6 is a plan view of the high density jetting apparatus array. As shown in FIG. 4, a silicon substrate 40 is provided. The substrate 40 has a thickness of approximately 675 μm. Similarly, a wet etching process using potassium hydroxide (KOH) solution is performed to form a manifold 41 penetrating the substrate 40. The resultant manifold 41 includes a front opening width of approximately 200 μm and a backside opening width of approximately 1156 μm. Because the etching rate of silicon in the crystalline directions <100> and <110> is faster than the etching rate in the crystalline direction <111 >, the manifold 41 with a conoid inner surface is formed.

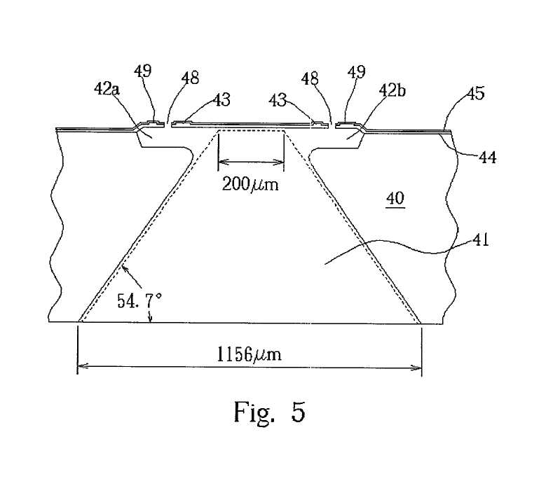

FIG. 5 shows a cross-sectional view of the jetting apparatus according to the present invention. Chambers 42a and 42b are formed on each side of the manifold 41. A top layer 44 made of silicon nitride or other ink resistant materials covers the chambers 42a, 42b and the substrate 40. Bubble generating devices 43 and 49 are formed over each chamber adjacent to the orifices 48. A protection layer 45 covers the bubble generating devices 43, 49 and the top layer. The orifices 48 are formed by using a laser etching process or a normal etching process.

As shown in FIG. 6, two rows of fluid chambers 42a and 42b (corresponding the orifices 48) are formed in a symmetric manner on two sides of a manifold 41. A conductive layer 46 and a resistor layer 47 laid over the chambers 42a and 42b constitute the bubble generating devices 43 and 49 around the orifices 48. The conductive layer 46 and the resistor layer 47 are made of materials known in the art.

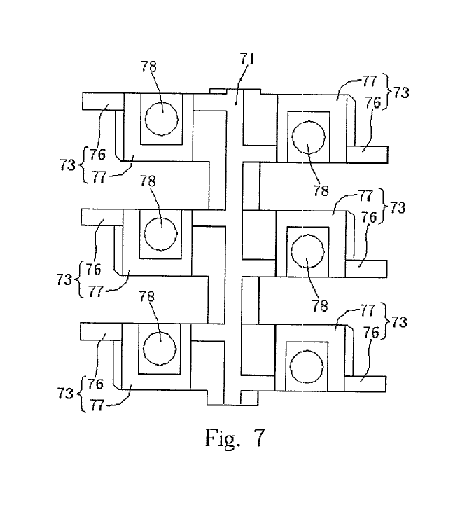

FIG. 7 is a diagram of a second embodiment of the invention. The difference between the second embodiment shown in FIG. 7 and the embodiment in FIG. 4 to FIG. 6 is the relative position between an orifice 78 and a manifold 71. Two sides of fluid chambers are arranged little asymmetrically with respect to the manifold 71, so that the orifice 78 is arranged little asymmetrically with respect to the manifold 71. As shown in the second embodiment in FIG. 7, the jetting devices are arranged asymmetrically to increase the number of orifices for improving printing quality.

The invention provides a third embodiment for decreasing the interference effect.

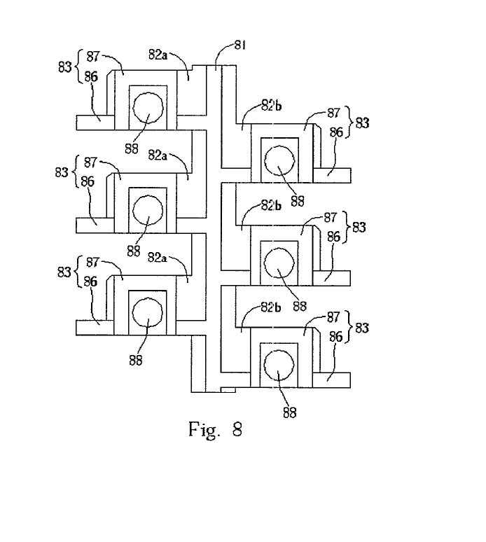

FIG. 8 is a schematic diagram of a third embodiment of the invention. The difference between the third and previous embodiments is also the relative position between an orifice 88 and a manifold 81. As shown in FIG. 8, two sides of fluid chambers 82a and 82b are arranged asymmetrically with respect to the manifold 81 in a predetermined distance, the orifice 88 is accordingly arranged asymmetrically with respect to the manifold 81 in a predetermined distanced. The predetermined distance is more than above second embodiment. This is done by arrangement of the jetting devices asymmetrically for increasing ink droplet density per unit distance wherein the jetting devices comprise a resistive layer and a conductive layer. Increasing the density of ink droplet per unit distance improves print resolution, resulting in better picture definition and quality.

The invention reduces the defect of a manifold disposed with a fluid chamber for two fluid chambers formed on two sides of a manifold. Increasing fluid chamber numbers per unit area and arranging orifices asymmetrically decreases turbulent effect, improving print quality.

The invention increases the number of orifices in the same size wafer and decreases turbulent effect. This results in better print quality and lower production costs of the printer.

Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A high density jetting apparatus comprising:
a substrate;
a manifold formed in the substrate for supplying fluid;
at least two fluid chambers formed at two sides of the manifold for passing the fluid from the manifold;
an orifice formed above each of the fluid chambers;
a first bubble generating device installed adjacent to one side of the orifice for heating fluid inside the fluid chamber so as to generate a first bubble; and
a second bubble generating device installed adjacent to another side of the orifice for heating fluid inside the fluid chamber so as to generate a second bubble subsequent to generation of the first bubble, ejecting fluid between the first and second bubbles from the orifice.

2. The high density jetting apparatus of claim 1 being a print head of an inkjet printer.

3. The high density jetting apparatus of claim 1 wherein the manifold is connected to an ink container for receiving fluid from the ink container.

4. The high density jetting apparatus of claim 1 wherein each of the first and second bubble generating device is a heater.

5. The high density jetting apparatus of claim 4 wherein the heater comprises a resistive layer and a conductive layer.

6. The high density jetting apparatus of claim 5 further comprising a passivation layer formed above the heater for isolating the heater from air.

7. The high density jetting apparatus of claim 1 further comprising a top layer formed between the each of the first and second bubble generating devices and each of the fluid chambers, the top layer comprising etching resistant material.

8. The high density jetting apparatus of claim 7 wherein the top layer is comprised of a silicon nitride layer.

9. The high density jetting apparatus of claim 7 wherein the substrate is a silicon substrate.

10. The high density jetting apparatus of claim 1 wherein the fluid chambers and the manifold are formed by performing a wet etching process.

11. The high density jetting apparatus of claim 1 wherein the orifice is formed by performing a laser etching or an etching process.

12. A high density jetting apparatus comprising:
a substrate;
a coated layer and at least two fluid chambers formed above the substrate;
a plurality of orifices each formed above a fluid chamber;
a first bubble generating device installed adjacent to one side of an orifice for heating fluid inside the fluid chamber so as to generate a first bubble;
a second bubble generating device installed adjacent to another side of the orifice for heating fluid inside the fluid chamber so as to generate a second bubble subsequent to generation of the first bubble; and
a manifold formed in the substrate for connecting a fluid container to the two fluid chambers so as to supply fluid stored in the fluid container to the two fluid chambers;
wherein the two fluid chambers are arranged at two sides of the manifold.

13. The high density jetting apparatus of claim 112 wherein the coated layer comprising a top layer, a resistive layer and a conductive layer.

14. The high density jetting apparatus of claim 13 wherein each of the first and second bubble generating devices comprises a heater, the heater comprising the resistive layer and the conductive layer.

15. The high density jetting apparatus of claim 14 wherein the orifices are arranged symmetrically or asymmetrically with respect to the manifold.

16. The high density jetting apparatus of claim 14 further comprising a passivation layer for isolating the heater from air, wherein the heater is formed above the top layer and the top layer is formed for isolating the heater from the fluid.

17. The high density jetting apparatus of claim 12 wherein the fluid chambers and the manifold are formed by performing a wet etching process.

18. The high density jetting apparatus of claim 12 wherein the orifice is formed by performing a laser etching or an etching process.

19. The high density jetting apparatus of claim 12 wherein the two fluid chambers are arranged symmetrically or asymmetrically with respect to the manifold.
